(19) United States
(12) Patent Application Publication
(10) Pub. No.: US 2015/0221429 A1
(43) Pub. Date: Aug. 6, 2015

(54) Planar Coil Module and Planar Transformer Using the Same

(71) Applicant: Wen-Hsiang WU LI, New Taipei (TW)

(72) Inventor: Wen-Hsiang WU LI, New Taipei (TW)

(21) Appl. No.: 14/173,030

(22) Filed: Feb. 5, 2014

(51) Int. Cl. H01F 27/29; H01F 27/28

(52) U.S. Cl. CPC H01F 27/292; H01F 27/2871

(57) ABSTRACT

Disclosed is a planar coil module comprising a first planar coil, a second planar coil and a connection portion to connect the first and second planar coils in series. The first and second coils respectively include an outer loop and an inner loop connected in series, with the inner loops of the first and second planar coils being connected by the connection portion. The first and second planar coils are provided in two neighboring planes and are separated by a distance. A planar transformer including the invented planar coil module is also disclosed.

### FIELD OF THE INVENTION

The present invention relates to a planar coil module, especially to a planar coil module for use in planar transformers. This invention provides a multiple-leveled, multiple-coiled planar coil module. The present invention also provide a planar transformer including the invented planar coil module.

### BACKGROUNDS OF THE INVENTION

The transformer is an important component for all kinds of electronic products. The traditional transformer is bulky and heavy. The planar transformer was then invented to provide the possibility of down-sizing and surface-mounting the transformer. A planar transformer includes plural layers of printed circuit boards provided with winding coils of conductive sheets, such as copper sheets, which reduce the thickness of the coils. The planar transformer is widely used in components in the fields of communications, computer, industrial control, aerospace engineering, medication etc. However, because the printed circuit board is used as substrate of the coils, the conventional planar transformer is thick and inefficient and generates high resistance and noises. Therefore, it is necessary for the industry to provide a thin and efficient planar transformer.

Taiwan patent No. TW I 387981 discloses a planar transformer, comprising a single, multilayered printed circuit board (PCB). The PCB includes a plurality of primary winding, a plurality of secondary winding and a through hole for a core to be arranged therein. This patent provides the possibility of laminating a plurality of winding layers in one PCB, whereby the thickness of the transformer is dramatically reduced. The structure disclosed in this patent is substantially identical to the traditional planar transformer, except that the PCB in the traditional planar transformer is replaced by a thin circuit layer.

Taiwan patent No. TW I 357086 provides a transformer arranged in a PCB. The transformer includes a first planar coil and a second planar coil, wherein the first coil includes a plurality of first loop and the second coil includes a plurality of second loop. At least two neighboring first loops form a first bundle of coils and at least two neighboring second loops form a second bundle of coils. The loops of the first bundle partially interpose that of the second.

Chinese patent No. CN 103081044A also discloses a planar transformer. The transformer comprises a plurality of single-layered, single-looped coils. Primary winding and secondary windings are formed by the single layered coils.

European patent EP 2 602 801A1 discloses a planar transformer comprising a secondary winding that includes a plurality of single-layered, single-looped coil layers. The primary winding is formed by a wire wound in a spiral along the secondary winding.

German patent application No. DE 10 2012 003 365A1 discloses a planar transformer that includes windings in the form of a single-layered and multiple-looped, planar structure. The terminal of the inner loop bends to pass a through hole provided at center of substrate on which the planar structure is arranged, to the opposite side of the substrate.

European patent No. EP 2 637 183A2 discloses a planar transformer that includes single-layered, single-looped coil layers as its windings. The coil layers extend to provide pads, to serve as connecting pins with another layer or electrode.

US patent publication No. US 2013/278371A1 discloses a planar transformer comprising a plurality of single-layered planar coils. A plurality of coils is connected and positioned by terminal pins vertically, to form coils of multiple loops.

WO 0070926A1 discloses a planar transformer including windings made by a single element. A sheet of conductive material is so designed, that when it is bent a multiple-layered, single-looped coil assembly is formed. The layers are connected by tabs in the form of a pad.

From the disclosure of these and other patents and non-patent documents, it is understood that the industry have spent substantial efforts in the development of planar transformers, in order to reduce their thickness and to enhance their performance. However, the structure of the planar transformer so developed remains the same of the PCB-style. Most solutions are the assembly of single-layered coils or coil layers as their units. None of them has provided a multi-loop structure for the planar coil.

### OBJECTIVES OF THE INVENTION

An objective of this invention is to provide a novel structure for the planar coil, so to substantially increase numbers of layer and loop in the planar coil.

Another objective of this invention is to provide a multilayered and multi-looped planar coil module.

Another objective of this invention is to provide a planar coil module that is easy to connect or assemble with other planar coil modules.

Another objective of this invention is to provide a planar transformer that includes a multilayered, multi-looped planar coil module.

Another objective of this invention is to provide a planar transformer that is easy to fabricate and usable in surface mounting.

### SUMMARY OF THE INVENTION

According to this invention, a novel planar coil module is provided and comprises a first planar coil, a second planar coil and a connection portion to connect the first and second planar coils in series. In the invented planar coil module, the first and second coils respectively include an outer loop and an inner loop, connected in series and separated by a first distance. The inner loops of the first and second planar coils are connected by the connection portion. The first and second planar coils are provided in two neighboring planes and are separated by a second distance. The outer loops of the first and second planar coils respectively include an outer terminal away from the inner loop. The outer terminals extend to form a pad.

In the preferred embodiments of this invention, the connection portion may be prepared by a conductive material other than that of the first planar coil and the second planar coil.

In some preferred embodiments, the planar coil module further includes an insulation sheet, arranged between the first and second coils. The insulation sheet may comprise a recession, to be engaged by the connection portion.

In some embodiments the first planar coil, the second planar coil and the connection portion are prepared from a single continuous blank. In other embodiments, however, the he first planar coil and the second planar coil are prepared separately and connected by the connection portion in a later step. In such embodiments, the connection portion may be a welder or an adhesive, conductive material.

In some embodiments, the first and second coils respectively form a circular spiral. In such embodiments the inner loops and outer loops of the first and second planar coils respectively form substantially a loop. In other embodiments the first and second coils respectively form a non-circular spiral, such as a polygonal spiral. In such embodiments the inner loops and outer loops of the first and second planar coils respectively form substantially a loop.

A planar transformer using the planar coil module of this invention may comprise a first planar coil module according to this invention, a second planar coil module stacked on the first planar coil module and a core. The core extends orthogonally to the plane of the two planar coil modules and passes through the central portion of the two coil modules. The second planar coil module includes at least a planar coil or planar coil layer. The planar transformer may further include a casing that encloses the core and the coil portions of the two planar coil modules.

These and other objectives and advantages of this invention will be clearly understood from the detailed description by referring to the following drawings.

### BRIEF DESCRIPTION OF THE DRAWINGS

FIG. 1 shows the structure of a planar transformer including a planar coil module of this invention.

FIG. 2 is the perspective view of one embodiment of the planar coil module of this invention.

FIG. 3 is an enlarged view of the connection portion of FIG. 2.

### DETAILED DESCRIPTION OF THE INVENTION

Detailed description to several preferred embodiments of this invention will be given below. It is however appreciated that the detailed description serves only for illustration of certain aspects of this invention, without limitation to the scope of protection.

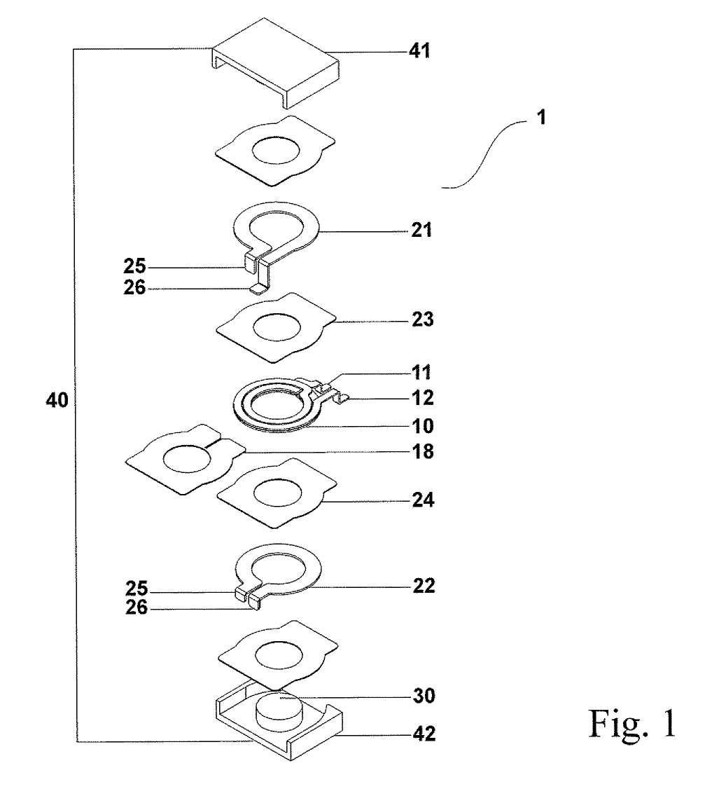

FIG. 1 shows the structure of a planar transformer that includes a planar coil module of this invention. As shown in this figure, the planar transformer 1 includes a planar coil module 10 of this invention, two single-layered, single-looped coil layers 21, 22, a core 30 and casing 40 formed by upper casing 41 and lower casing 42. The planar coil module 10 is sandwiched by the two coil layers 21, 22 and isolated from the later by insulation sheets 23, 24. A through hole is provided in the central parts of the planar coil module 10, the two coil layers 21, 22 and the insulation sheets 23, 24. The core 30 extends vertically to the planes of the planar coil module 10, the two coil layers 21, 22 and the insulation sheets 23, 24 and through the through hole. Two pads 11, 12 extend from the planar coil module 10 to its external. The two coil layers 21, 22 are connected in series and extend to respectively form a pad 25, 26. Pads 11, 12 of the planar coil module 10 locate at a side of the transformer 1 opposite to the side where pads 25, 26 of the two coil layers 21, 22 locate. This, of course, is not any technical limitation. One or both pads 11, 12 may locate at the side where one or both pads 25, 26 locate. These elements are assembled to form a planar transformer 1.

In the transformer 1, upper casing 41 and lower casing 42 enclose the core 30 and the coil portions of the planar coil module 10 and the coil layers 21, 22. The casing 40 does not only protect the transformer 1 but also provide EMR shielding functions. Pad 11 of the planar coil module 10 and pads 25, 26 of the coil layers 21, 22 respectively form soldering pads, so that the planar transformer 1 may be mounted on a circuit board using the surface mounting (SMT) technology.

In the embodiments of this invention, the planar coil module 10 and the coil layers 21, 22 are made by materials with high conductivity. Suited materials include all kinds of metal or alloys, such as copper, silver, brass etc. The two coil layers 21, 22 may be any form or type of planar coil, such as those disclosed in the prior art documents mentioned above. Of course, one or more of the two coil layers 21, 22 may also be a planar coil module according to this invention. Number of the planar coil module 10 and the coil layers 21, 22 is not limited by the example of FIG. 1. A designer of transformer may determine, according to needs in particular applications. In addition, the coils and coil layers need not to completely overlap each other. One coil or coil layer may offset or interpose another, such as that shown in the above-mentioned DE 10 2012 003 365A1.

On the other hand, the core 30 may be any type of commercially available cores. The material, shape and size of the core 30 may be determined by those having ordinary skills in the art in accordance with related requirements and conditions in particular applications. In addition, casing 40 for the transformer is not limited to any form. A casing made from one-piece blank or by the assembly of more than two elements may also be used in this invention. If necessary, one of the upper casing and the lower casing may be omitted. It is also possible to use more than one or one layer of upper casing and/or lower casing. These are, of course, not any technical limitation.

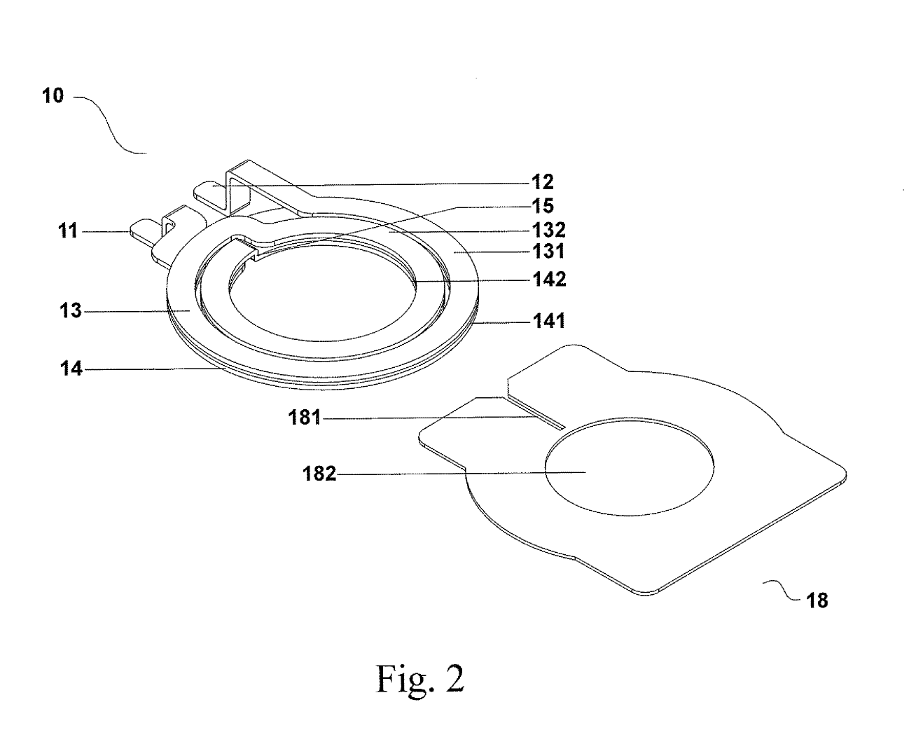

FIG. 2 shows the perspective view of one embodiment of the planar coil module of this invention. The planar coil module 10 shown in FIG. 2 includes a first planar coil 13, a second planar coil 14 and connection portion 15 connecting the first planar coil 13 and the second planar coil 14. First planar coil 13 and second planar coil 14 are arranged in two neighboring planes, with a predetermined distance between them. In this embodiment, the first planar coil 13, the second planar coil 14 and the connection portion 15 form a continuous piece of material, preferably from a material of high conductivity. Suited materials include all kinds of metal and alloys, such as copper, silver, brass etc. However, this is not any technical limitation. The single piece that forms the first planar coil 13, the second planar coil 14 and the connection portion 15 may be prepared by any suitable metal process technique, including coating, low temperature deformation, high temperature deformation, cutting, pressing, etching and other known metal process technologies, or any combination thereof.

The first planar coil 13, the second planar coil 14 and the connection portion 15 may also be prepared separately. For example, the first planar coil 13 and the second planar coil 14 may be fabricated separately and are connected using the connection portion 15. In such embodiments, the connection portion 15 may be a welding material or an adhesive conductive material. When such approach is used, care must be taken to ensure the first planar coil 13 and the second planar coil 14 are connected in series by the connection portion 15.

FIG. 2 also shows that first planar coil 13 and second planar coil 14 respectively include an outer loop 131, 141 and an inner loop 132, 142, connected in series and separated by a predetermined distance. Although in this embodiment, each planar coil includes two loops, this is not any technical limitation. It is possible to use more than two loops in any one of the planar coils 13 and 14. Specifically speaking, number of the loop is determined according to factors such as conversion rate, width of loop, distance between neighboring loops and/or diameter of core 70. In addition, width, thickness and even shape of respective loop may also be determined according to conditions in particular applications. Generally speaking, the windings are preferably formed in planar loops, so to save material and to facilitate process of the windings.

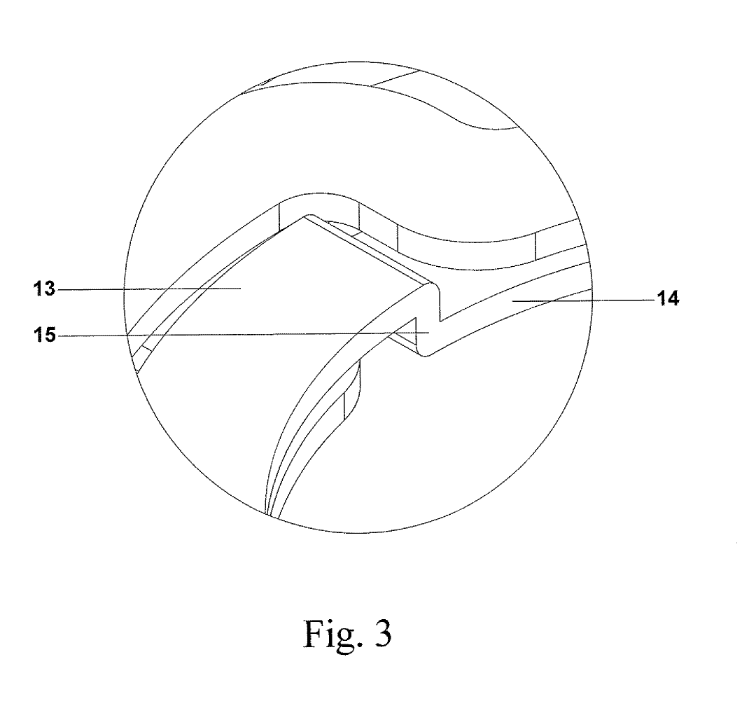

In the embodiment shown in FIG. 2, the connection portion 15 connects the inner loops 132, 142 of the two planar coils 13, 14, allowing all loops of the two planar coils 13, 14 to extend in the same direction. FIG. 3 shows the enlarged view of the connection portion 15. As shown in this figure, connection portion 15 connects the first planar coil 13 and the second planar coil 14 and forms a stage difference between them. That is, the first planar coil 13 and the second planar coil 14 are connected in series, arranged in two neighboring planes and separated by a distance. Of course, shape of the connection portion 15 is not limited to the example of FIG. 3. For example, the connection portion 15 may form a slope, such that the first planar coil 13 and the second planar coil 14 are arranged in two neighboring planes and separated by a distance. If the connection portion 15 is a welding material or an adhesive conductive material, shape of the connection portion 15 would be a welder layer or an adhesion layer that connects the first planar coil 13 and the second planar coil 14 in series and separate them by a distance.

At the outer loops 131, 141 of the two planar coils 13, 14, at the terminal away from their inner loops 132, 142, the coils extend to respectively form a pad 11, 12. The pads 11, 12 may further be bent to form bonding pads for use in the SMT process. In addition, one or more pads 11, 12 may further extend transversely to form bonding pads of large size, to provide securing and/or heat-dissipation functions. In the preferred embodiments of this invention, each pad 11, 12 is arranged at one of the positions where bonding pads of the standard surface mounting device (SMD) locate.

In FIG. 2, both the first planar coil 13 and the second planar coil 14 are circular spiral, i.e., with a circular contour. Such design provides relative higher conversional efficiency. However, the present invention is not limited to spiral or circular windings. Other shapes of the winding, such as rectangular or polygonal spirals that are used in the conventional art, may also be used in this invention. In the windings of FIG. 2, the inner loops 132, 142 and outer loops 131, 141 of the first and second planar coils 13, 14 respectively form substantially a loop. Such design ensures the maximum winding angle of the loops. Of course, this is not any technical limitation. In other embodiments the first and second coil layers respectively form a non-circular spiral, such as a polygonal spiral. In such embodiments the inner loops 132, 142 and outer loops 131, 141 of the first and second planar coils 13, 14 respectively form substantially a loop, so to obtain maximum winding angles.

In the embodiment of FIG. 2, the planar coil module 10 further includes an insulation sheet 18, sandwiched by the first planar coil 13 and the second planar coil 14 to electrically isolate the two planar coils 13, 14. Any commercially available insulation material is useful in fabricating the insulation sheet 18, as long as the material is easy to process and provides acceptable insulation effects. The insulation sheet 18 is preferably thin but shall have a sufficient thickness, in order not to damage its insulation effects. A recession 181 is provided in the insulation sheet 18, so that the connection portion 15 may plug in the recession 181, to form a robust planar coil module 10. The recession 181 may extend to a depth in correspondence with the position of the connection portion 15 to be determined in application. However, extension of the recession 181 preferably stops before reaching hole 182 at center of the insulation sheet 18.

If necessary, adhesives may be applied to one or both surfaces of the insulation sheet 18, to secure the first planar coil 13 and/or the second planar coil 14 on the insulation sheet 18. In addition, when desirable, insulation layer (not shown) may be applied to the winding surface of the first planar coil 13 and/or the second planar coil 14, so to enhance isolation of the windings.

When assembly, the windings of the planar coil module 10 are preferably overlapped by the windings of the coil layers 21, 22 (FIG. 1). Of course, it is possible to so arrange that coils of the primary winding offset or interpose that of the secondary winding.

As described above, the present invention provides a novel structure for the planar coil module. The planar coil module has a multilayered, multiple-looped structure and provides a wide degree of freedom in designing the planar coil module. The windings of the planar coil module may be made from a single blank and is easy to fabricate and assemble. No printed circuit board is needed in the preparation of the invented planar coil module. Thickness of the planar transformer is thus dramatically reduced. In addition, because a multi-layered, multi-looped planar coil module may be fabricated as one single piece of material, resistance generated in the module is reduced and performance is thus improved.

What is claimed is:

1. A planar coil module, comprising a first planar coil, a second planar coil and a connection portion to connect the first and second planar coils in series;
wherein the first and second coils respectively include an outer loop and an inner loop, connected in series and separated by a first distance, with the inner loops of the first and second planar coils connected by the connection portion;
wherein the first and second planar coils are provided in two neighboring planes and are separated by a second distance; and
wherein the outer loops of the first and second planar coils respectively include an outer terminal away from the inner loop, wherein the outer terminals extend to form a pad.

2. The planar coil module according to claim 1, wherein the connection portion is prepared from a conductive material other than material for the first planar coil and the second planar coil.

3. The planar coil module according to claim 1, further including an insulation sheet, arranged between the first and second coils.

4. The planar coil module according to claim 3, wherein the insulation sheet comprises a recession, to be engaged by the connection portion.

5. The planar coil module according to claim 1, wherein the first planar coil, the second planar coil and the connection portion are prepared from a single continuous blank.

6. The planar coil module according to claim 1, wherein the connection portion is one selected from the group consisted of a welder and an adhesive and conductive material.

7. The planar coil module according to claim 1, wherein the first and second coil respectively form a circular spiral.

8. The planar coil module according to claim 7, wherein the inner loops and outer loops of the first and second planar coils respectively form substantially a loop.

9. The planar coil module according to claim 1, wherein the first and second coils respectively form a polygonal spiral.

10. The planar coil module according to claim 9, wherein the inner loops and outer loops of the first and second planar coils respectively form substantially a loop.

11. A planar transformer, comprising a first planar coil module, a second planar coil module stacked on the first planar coil module and a core,
wherein the first planar coil module comprises a first planar coil, a second planar coil and a connection portion to connect the first and second planar coils in series;
wherein the first and second coils respectively include an outer loop and an inner loop, connected in series and separated by a first distance, with the inner loops of the first and second planar coils connected by the connection portion;
wherein the first and second planar coils are provided in two neighboring planes and are separated by a second distance; and
wherein the outer loops of the first and second planar coils respectively include an outer terminal away from the inner loop, wherein the outer terminals extend to form a pad;
wherein the second planar coil module includes at least a planar coil; and
wherein the core extends orthogonally to the plane of the two planar coil modules and passes through the central portion of the two coil modules.

12. The planar transformer according to claim 11, further comprising a casing enclosing the core and the coil portions of the two planar coil modules.

13. The planar transformer according to claim 11, wherein the connection portion is prepared from a conductive material other than material for the first planar coil and the second planar coil.

14. The planar transformer according to claim 11, wherein the first planar coil module further comprises an insulation sheet, arranged between the first and second coils.

15. The planar transformer according to claim 14, wherein the insulation sheet comprises a recession, to be engaged by the connection portion.

16. The planar transformer according to claim 11, wherein the first planar coil, the second planar coil and the connection portion of the first planar coil module are prepared from a single continuous blank.

17. The planar transformer according to claim 11, wherein the connection portion is one selected from the group consisted of a welder and an adhesive and conductive material.

18. The planar transformer according to claim 11, wherein the first and second coil of the first planar coil module respectively form a circular spiral.

19. The planar transformer according to claim 18, wherein the inner loops and outer loops of the first and second planar coils respectively form substantially a loop.

20. The planar transformer according to claim 11, wherein the first and second coils of the first planar coil module respectively form a polygonal spiral.

21. The planar transformer according to claim 20, wherein the inner loops and outer loops of the first and second planar coils respectively form substantially a loop.
